(19) United States
(12) Patent Application Publication
(10) Pub. No.: US 2012/0136171 A1
(43) Pub. Date: May 31, 2012

(54) METHOD FOR THE MANUFACTURE OFAMINO ALKYLENE PHOSPHONIC ACIDS

(75) Inventors: Patrick Notté, Wavre (BE); Cedric Nicolas Pirard, Romsee (Fleron) (BE); David Lemin, Watermael-Boitsfort (BE)

(73) Assignee: STRAITMARK HOLDING AG, Zug (CH)

(21) Appl. No.: 13/322,442

(22) PCT Filed: May 28, 2010
(86) PCT No.: PCT/EP2010/057425

§ 371 Date: Feb. 8, 2012

(30) Foreign Application Priority Data
May 28, 2009 (EP) 09161397.6

(51) Int. Cl. C07F 9/38; C07F 9/22

(52) U.S. Cl. 562/10; 562/14; 562/12

(57) ABSTRACT

A method for the manufacture of aminoalkylene phosphonic acids broadly is disclosed. In the essence, an amine corresponding to a specific formula is reacted in aqueous medium with phosphorous acid and formaldehyde to thereby yield a medium insoluble reaction product. The insoluble product formed i.e. the aminoalkylene phosphonic acid can be separated, optionally washed, and recovered. This process yields high purity and selectivity reaction products. The excess phosphonic acid can be recycled into the processing sequence.

This invention concerns a method for the manufacture of a broad range of aminoalkylene phosphonic acids. In particular, aminoalkylene phosphonic acids corresponding to a general formula can be prepared starting from reacting in an aqueous medium a specifically defined amine, phosphorous acid, to be used in excess of 100% to 600%, and formaldehyde to thereby yield a medium insoluble reaction product. The reaction product, i.e. the aminoalkylene phosphonic acid can be separated and washed in accordance with needs and recovered in a conventional manner. The excess of phosphorous acid can be calculated by multiplying the sum of the N atoms in the amine by the number of moles of amine being reacted multiplied by 1 to 6 to thus determine the number of moles of phosphorous acid to be used, in addition to the stoichiometric level required for the reaction. In a preferred embodiment, the phosphorous acid is prepared in situ starting from P₄O₆.

Aminoalkylene phosphonic acid compounds are generally old in the art and have found widespread commercial acceptance for a variety of applications including water-treatment, scale-inhibition, detergent additives, sequestrants, marine-oil drilling adjuvants and as pharmaceutical components. It is well known that such industrial applications preferably require amino alkylene phosphonic acids wherein a majority of the N—H functions of the ammonia/amine raw material have been converted into the corresponding alkylene phosphonic acid. The art is thus, as one can expect, crowded and is possessed of methods for the manufacture of such compounds. The state-of-the-art manufacture of amino alkylene phosphonic acids is premised on converting phosphorous acid resulting from the hydrolysis of phosphorus trichloride or on converting phosphorous acid via the addition of hydrochloric acid which hydrochloric acid can be, in part or in total, added in the form of an amine hydrochloride.

The manufacture of amino alkylene phosphonic acids is described in GB 1.142.294. This art is premised on the exclusive use of phosphorus trihalides, usually phosphorus trichloride, as the source of the phosphorous acid reactant. The reaction actually requires the presence of substantial quantities of water, frequently up to 7 moles per mole of phosphorus trihalide. The water serves for the hydrolysis of the phosphorus trichloride to thus yield phosphorous and hydrochloric acids. Formaldehyde losses occur during the reaction which is carried out at mild temperatures in the range of from 30-60° C. followed by a short heating step at 100-120° C. GB 1.230.121 describes an improvement of the technology of GB 1.142.294 in that the alkylene polyaminomethylene phosphonic acid may be made in a one-stage process by employing phosphorus trihalide instead of phosphorous acid to thus secure economic savings. The synthesis of aminomethylene phosphonic acids is described by Moedritzer and Irani, J. Org. Chem., Vol. 31, pages 1603-1607 (1966). Mannich-type reactions, and other academic reaction mechanisms, are actually disclosed. Optimum Mannich conditions require low-pH values such as resulting from the use of 2-3 moles of concentrated hydrochloric acid/mole of amine hydrochloride. The formaldehyde component is added drop wise, at reflux temperature, to the reactant solution mixture of aminehydrochloride, phosphorous acid and concentrated hydrochloric acid. U.S. Pat. No. 3,288,846 also describes a process for preparing aminoalkylene phosphonic acids by forming an aqueous mixture, having a pH below 4, containing an amine, an organic carbonyl compound e.g. an aldehyde or a ketone, and heating the mixture to a temperature above 70° C. whereby the amino alkylene phosphonic acid is formed. The reaction is conducted in the presence of halide ions to thus inhibit the oxidation of orthophosphorous acid to orthophosphoric acid. WO 96/40698 concerns the manufacture of N-phosphonomethyliminodiacetic acid by simultaneously infusing into a reaction mixture water, iminodiacetic acid, formaldehyde, a source of phosphorous acid and a strong acid. The source of phosphorous acid and strong acid are represented by phosphorus trichloride. Shen Guoliang et al., “Study on synthesis process and application of ethylene diamine tetramethylenephosphonic acid” Huagong shikan, 20(1), 50-53 (abstract) disclose the synthesis of ethylenediamine (tetramethylene phosphonic acid) in stoechiometric conditions. CN101323627 discloses a method for producing bis(hexamethylenetriamine) penta(methylenephosphonic acid) without an excess of any components.

The use of phosphorus trichloride for preparing aminopolyalkylene phosphonic acids is, in addition, illustrated and emphasized by multiple authors such as Long et al. and Tang et al. in Huaxue Yu Nianhe, 1993 (1), 27-9 and 1993 34(3), 111-14 respectively. Comparable technology is also known from Hungarian patent application 36825 and Hungarian patent 199488. EP 125766 similarly describes the synthesis of such compounds in the presence of hydrochloric acid. EP 1681295 describes the manufacture of aminoalkylene phosphonic acids under substantial exclusion of hydrohalogenic acid by reacting phosphorous acid, an amine and formaldehyde in the presence of a heterogeneous Broensted acid catalyst. Suitable catalyst species can be represented by fluorinated carboxylic acids and fluorinated sulfonic acids having from 6 to 24 carbon atoms in the hydrocarbon chain. EP 1681294 pertains to a method for the manufacture of aminopolyalkylene phosphonic acids under substantial exclusion of hydrohalogenic acid by reacting phosphorous acid, an amine and formaldehyde in the presence of a homogeneous acid catalyst having a pKa equal to or smaller than 3.1. The acid catalyst can be represented by sulphuric acid, sulfurous acid, trifluoroacetic acid, trifluoromethane sulfonic acid, oxalic acid, malonic acid, p-toluene sulfonic acid and naphthalene sulfonic acid. EP 2 112 156 describes the manufacture of aminoalkylene phosphonic acids by adding P₄O₆ to an aqueous reaction medium containing a homogeneous Broensted acid whereby the aqueous medium can contain an amine or wherein the amine is added simultaneously with the P₄O₆ or wherein the amine is added after completion of the P₄O₆ addition, whereby the pH of the reaction medium is maintained at all times below 5 and whereby the reaction partners, phosphorous acid/amine/formaldehyde/Broensted acid, are used in specifically defined proportions.

JP patent application 57075990 describes a method for the manufacture of diaminoalkane tetra(phosphonomethyl) by reacting formaldehyde with diaminoalkane and phosphorous acid in the presence of a major level of concentrated hydrochloric acid.

Phosphorus oxides and the hydrolysis products thereof are extensively described in the literature. Canadian patent application 2.070.949 divulges a method for the manufacture of phosphorous acid, or the corresponding P₂O₃ oxide, by introducing gaseous phosphorus and steam water into a gas plasma reaction zone at a temperature in the range of 1500° K to 2500° K to thus effect conversion to P₂O₃ followed by rapidly quenching the phosphorus oxides at a temperature above 1500° K with water to a temperature below 1100° K to thus yield H₃PO₃ of good purity. In another approach, phosphorus(I) and (III) oxides can be prepared by catalytic reduction of phosphorus(V) oxides as described in U.S. Pat. No. 6,440,380. The oxides can be hydrolyzed to thus yield phosphorous acid. EP-A-1.008.552 discloses a process for the preparation of phosphorous acid by oxidizing elemental phosphorus in the presence of an alcohol to yield P(III) and P(V) esters followed by selective hydrolysis of the phosphite ester into phosphorous acid. WO 99/43612 describes a catalytic process for the preparation of P(III) oxyacids in high selectivity. The catalytic oxidation of elemental phosphorus to phosphorous oxidation levels is also known from U.S. Pat. Nos. 6,476,256 and 6,238,637.

DD 206 363 discloses a process for converting P₄O₆ with water into phosphorous acid in the presence of a charcoal catalyst. The charcoal can serve, inter alia, for separating impurities, particularly non-reacted elemental phosphorus. DD 292 214 also pertains to a process for preparing phosphorous acid. The process, in essence, embodies the preparation of phosphorous acid by reacting elementary phosphorus, an oxidant gas and water followed by submitting the reaction mixture to two hydrolysing steps namely for a starter at molar proportions of P₄:H₂O of 1:10-50 at a temperature of preferably 1600-2000° K followed by completing the hydrolysis reaction at a temperature of 283-343° K in the presence of a minimal amount of added water.

The art in substance contemplates synthesizing aminoalkylene phosphonates in multi step arrangements which, for a cumulative series of reasons, were found to be deficient and economically non-viable. However, quite in general, P₄O₆ is not available commercially and has not found commercial application. The actual technology used for the manufacture of aminoalkylene phosphonic acids is based on the PCl₃ hydrolysis with its well known deficiencies ranging from the presence of hydrochloric acid, losses of PCl₃ due to volatility and entrainement by HCl and the formation of chlorine containing by-products e.g. methyl chloride. The inventive technology aims at providing technologically new, economically acceptable routes to synthesize the aminoalkylene phosphonic acid compounds in a superior manner consonant with standing desires.

It is a major object of this invention to manufacture aminoalkylene phosphonic acids with high selectivity and yields. It is another aim of this invention to provide a one step manufacturing arrangement capable of delivering superior compound grades. Yet another object of this invention seeks to synthesize the phosphonic acid compounds in a shortened and energy efficient manner. Yet another aim seeks to provide an efficient reaction system which can preferably be operated under exclusion of reactants foreign to the system. It is another aim of this invention to provide aminoalkylene phosphonic acid manufacturing technology with reduced catalyst inconvenience, in particular to forego and circumvent catalyst isolation, destruction and removal.

The term “percent” or “%” as used throughout this application stands, unless defined differently, for “percent by weight” or “% by weight”. The terms “phosphonic acid” and “phosphonate” are also used interchangeably depending, of course, upon medium prevailing alkalinity/acidity conditions. The term “ppm” stands for “parts per million”. The terms “P₂O₃” and “P₄O₆” can be used interchangeably. Unless defined differently, pH values are measured at 25° C. on the reaction medium as such. The designation “phosphorous acid” means phosphorous acid as such, phosphorous acid prepared in situ starting from P₄O₆ or purified phosphorous acid starting from PCl₃ or purified phosphorous acid resulting from the reaction of PCl₃ with carboxylic acid, sulfonic acid or alcohol to make the corresponding chloride. The term “amine” embraces amines per se and ammonia. The term “formaldehyde” designates interchangeably formaldehyde, sensu stricto, aldehydes and ketones. The term “amino acid” means amino acids in their D, L, and D,L forms and mixtures of the D and L forms. The term mother liquid designates the continuous liquid phase of the reaction medium. The term “optionally substituted” means that the specified group is unsubstituted or substituted by one or more substituents, independently chosen from the group of possible substituents.

The term “liquid P₄O₆” embraces P₄O₆ in the liquid state, solid P₄O₆ and gaseous P₄O₆. The term “ambient” with respect to temperature and pressure means usually prevailing terrestrial conditions at sea level e.g. temperature is about 18° C.-25° C. and pressure stands for 990-1050 mm Hg.

The foregoing and other objects can now be met by using the technology of this invention, basically a system for reacting an amine, phosphorous acid in a significant excess and formaldehyde to thereby yield a reaction medium insoluble product which can be recovered routinely. In more detail the invention herein concerns a method for the manufacture of aminoalkylene phosphonic acids having the formula (I):

(X)ₐ[N(W)(Y)₂₋ₐ]_{z} (I)

wherein X is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; ZPO₃M₂; [V—N(K)]ₙ—K; [V—N(Y)]ₙ—V or [V—O]ₓ—V, wherein V is selected from a C₂₋₅₀ linear, branched, cyclic or aromatic hydrocarbon radical, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical, wherein G is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; ZPO₃M₂; [V—N(K)]ₙ—K; [V—N(Y)]ₙ—V or [V—O]ₓ—V; wherein Y is ZPO₃M₂, [V—N(K)]ₙ—K or [V—N(K)]ₙ—V, and x is an integer from 1-50000; z is from 0-200000, whereby z is equal to or smaller than the number of carbon atoms in X, and a is 0 or 1; n is an integer from 0 to 50000, preferably from 1 to 50000; z=1 when a=0; and X is [V—N(K)]ₙ—K or [V—N(Y)]ₙ—V when z=0 and a=1;

Z is a methylene group;

M is selected from H, protonated amine, ammonium, alkali and earth-alkali cations;

W is selected from H, X and ZPO₃M₂ with the proviso that X and W cannot simultaneously represent CH₂COOH;

K is ZPO₃M₂ or H whereby K is ZPO₃M₂ when z=0 and a=1 or when W is H or X;

a) by reacting in an aqueous medium an amine having the general formula (II):

(X)_{b}[N(W)(H)_{2-b}]_{z} (II)

wherein X is selected from C₁-C₂₀₀₀₀₀, preferably C₁-C₅₀₀₀₀, most preferably C₁₋₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; H; [V—N(H)]ₓ—H or [V—N(Y)]ₙ—V or [V—O]ₓ—V wherein V is selected from: a C₂₋₅₀ linear, branched, cyclic or aromatic hydrocarbon radical, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical; wherein G is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; H; [V—N(H)]ₙ—H; [V—N(Y)]ₙ—V or [V—O]ₓ—V; wherein Y is H, [V—N(H)]ₙ—H or [V—N(H)]ₙ—V, and x is an integer from 1-50000; n is an integer from 0 to 50000; z is from 0-200000 whereby z is equal to or smaller than the number of carbon atoms in X, and b is 0, 1 or 2; z=1 when b=0; and X is [V—N(H)]ₓ—H or [V—N(Y)]ₙ—V, b=1 and n is an integer from 1 to 50000 when z=0; with W=H when X different from H and b=2; z=1 when W and X are hydrogen.

W is selected from H and X, with the proviso that X and W cannot simultaneously represent CH₂COOH; and

phosphorous acid, in excess of from 100% to 600%, which excess is calculated by multiplying the sum of the N atoms in the amine by the number of moles of amine being reacted multiplied by 1 to 6 to thus determine the number of moles of phosphorous acid to be used in addition to the stoichiometric level required by the reaction; and formaldehyde; at a temperature in the range of from 45° C. to 200° C. for a period of from 1 minute to 10 hours, to thereby yield a reaction product, which is insoluble in the reaction medium; and
b) separating and optionally washing the insoluble reaction product.
a) In another embodiment of the invention step (a) of the inventive method is caddied out by reacting an amine having the general formula (II):

(X)_{b}[N(W)(H)_{2-b}]_{z} (II)

wherein X is selected from C₁-C₂₀₀₀₀₀ linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; H; [V—N(H)]ₓ—H or [V—N(Y)]ₙ—V or [V—O]ₓ—V wherein V is selected from: a C₂₋₅₀ linear, branched, cyclic or aromatic hydrocarbon radical, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical; wherein G is selected from C₁-C₂₀₀₀₀₀ linear, branched, cyclic or aromatic hydrocarbon radicals, optionally substituted by one or more C₁-C₁₂ linear, branched, cyclic and/or aromatic groups, which radicals and/or which groups are optionally substituted by OH, COOH, COOR′, F, Br, Cl, I, OR′, SO₃H, SO₃R′ and/or SR′ moieties; H; [V—N(H)]ₙ—H; [V—N(Y)]ₙ—V or [V—O]ₓ—V; wherein Y is H, [V—N(H)]ₙ—H or [V—N(H)]ₙ—V and x is an integer from 1-50000; n is an integer from 0 to 50000; z is from 0-200000 whereby z is equal to or smaller than the number of carbon atoms in X, and b is 0, 1 or 2; z=1 when b=0; and X is [V—N(H)]ₓ—H or [V—N(Y)]ₙ—V when z=0 and b=1; with W different from H when X=H;

W is selected from H and X with the proviso that X and W cannot simultaneously represent CH₂COOH; and

phosphorous acid, in excess of from 100% to 600%, which excess is calculated by multiplying the sum of the N atoms in the amine by the number of moles of amine being reacted multiplied by 1 to 6 to thus determine the number of moles of phosphorous acid to be used in addition to the stoichiometric level required by the reaction; and a formaldehyde component, comprising formaldehyde, another aldehyde and/or a ketone; at a temperature in the range of from 45° C. to 200° C. for a period of from 1 minute to 10 hours, to thereby yield a reaction product, which is insoluble in the reaction medium. Step (b) follows as described above.

It is understood that the claimed technology is particularly beneficial in that the reaction medium is uniform and that the reaction partners are identical to the constituents of the products to be manufactured i.e. the system operates under exclusion of system-foreign components with its obviously significant benefits. This includes, inter alia, the fact that after the separation of the reaction product, the remaining part of the reaction medium, i.e. the mother liquid, can generally be recycled without any limitation. In some cases the insolubility of the reaction product in the reaction medium can be enhanced by adding water and/or a water-soluble organic diluent. So proceeding requires routine measures well known in the domain of separation technology. Examples of suitable organic solvents include alcohols e.g. ethanol and methanol. The levels of the precipitation additives e.g. water/alcohol to be used vary based on the reaction medium and can be determined routinely. It goes without saying that the organic solvents shall be removed, e.g. by distillation, before the mother liquid is recycled.

The insoluble amino alkylene phosphonic acid reaction product can be separated from the liquid phase, e.g. for recovery purposes, by physical means known in the art e.g. by settling, filtration or expression. Examples of the like processes include gravity settling sometimes through exercising centrifugal force e.g. in cyclones; screen, vacuum or centrifugal filtration; and expression using batch or continuous presses e.g. screw presses.

The phosphorous acid reactant is a commodity material well known in the domain of the technology. It can be prepared, for example, by various technologies some of which are well known, including hydrolysing phosphorus trichloride or P-oxides. Phosphorous acid and the corresponding P-oxides can be derived from any suitable precursor including naturally occurring phosphorus containing rocks which can be converted, in a known manner, to elemental phosphorus followed by oxidation to P-oxides and possibly phosphorous acid. The phosphorous acid reactant can also be prepared, starting from hydrolyzing PCl₃ and purifying the phosphorous acid so obtained by eliminating hydrochloric acid and other chloride intermediates originating from the hydrolysis. In another approach, phosphorous acid can be manufactured beneficially by reacting phosphorus trichloride with a reagent which is either a carboxylic acid or a sulfonic acid or an alcohol. The PCl₃ reacts with the reagent under formation of phosphorous acid and an acid chloride in the case of an acid reagent or a chloride, for example an alkylchloride, originating from the reaction of the PCl₃ with the corresponding alcohol. The chlorine containing products, e.g. the alkylchloride and/or the acid chloride, can be conveniently separated from the phosphorous acid by methods known in the art e.g. by distillation. While the phosphorous acid so manufactured can be used as such in the claimed arrangement, it is desirable and it is frequently preferred to purify the phosphorous acid formed by substantially eliminating or diminishing the levels of chlorine containing products and non-reacted raw materials. Preferably, phosphorous acid prepared from PCl₃ contains less than 400 ppm of chlorine, expressed in relation to the phosphorous acid (100%). Such purifications are well known and fairly standard in the domain of the relevant manufacturing technology. Suitable examples of such technologies include the selective adsorption of the organic impurities on activated carbon or the use of aqueous phase separation for the isolation of the phosphorous acid component. Information pertinent to the reaction of phosphorous trichloride with a reagent such as a carboxylic acid or an alcohol can be found in Kirk-Othmer, Encyclopedia of Chemical Technology, in chapter Phosphorous Compounds, Dec. 4, 2000, John Wiley & Sons Inc.

In a particularly preferred execution herein, the phosphorous acid is prepared starting from liquid P₄O₆ which is added to the aqueous reaction medium having, at all times, a pH below 5, preferably below 3, particularly below 2, whereby the reaction medium is selected from:
i: an aqueous reaction medium containing the amine (II);
ii: an aqueous reaction medium wherein the amine (II) is added simultaneously with the P₄O₆; and
iii: an aqueous reaction medium wherein the amine (II) is added after the addition/hydrolysis of the P₄O₆ has been completed.

It is understood that the pH of the reaction medium, ab initio and at all times, is preferably controlled by the presence of phosphorous acid.

The simultaneous addition of the amine and the P₄O₆ shall preferably be effected in parallel, i.e. a premixing, before adding to the reaction medium, of the amine and the P₄O₆ shall for obvious reasons be avoided.

The phosphorous acid shall be used in an excess of from 100% to 600%, preferably from 100% to 500%, in particular from 200% to 400%. The excess of phosphorous acid is calculated by multiplying the sum of the N atoms in the amine by the number of moles of amine being reacted multiplied by 1 to 6 to thus quantify the number of moles of excess phosphorous acid to be used. The phosphorous acid actually enhances the reaction without requiring any measure except the recirculation of the phosphorous acid containing mother liquid, as a homogeneous reactant, to the reaction medium. The absence of any products foreign to the composition of the phosphonic acids to be synthesized constitutes a considerable step forward in the domain of the technology on account of purification and separation methods currently required in the application of the art technology.

The reagents are used in the method of this invention generally in stoichiometric proportions considering the structure of the selected phosphonic acid to be manufactured. This relationship applies to the phosphorous acid, the amine and the formaldehyde and covers the level of reagent needed in the synthesis under exclusion of the excess of 100% to 600% of phosphorous acid, as explained in the description and recited in the claims. Specifically, the reagents: (α) phosphorous acid; (β) amine (II); and (γ) formaldehyde component; are used in ratios as follows:

(α):(β) from 0.05:1 to 2:1;

(γ):(β) from 0.05:1 to 5:1; and

(γ):(α) from 5:1 to 0.25:1;

whereby (α) and (γ) stand for the number of moles and (β) represents the number of moles multiplied by the number of N—H functions in the amine (II). It is understood that the “excess” phosphorous acid, particularly from 200% to 400%, determined as set forth in the application papers, is additional to the foregoing ratio levels.

In a more preferred execution, the reactant ratios are as follows:

(α):(β) of from 0.1:1 to 1.50:1;

(γ):(β) of from 0.2:1 to 2:1; and

(γ):(α) of from 3:1 to 0.5:1.

Particularly preferred ratios are:

(α):(β) of from 0.4:1 to 1.0:1.0;

(γ):(β) of from 0.4:1 to 1.5:1; and

(γ):(α) of from 2:1 to 1.0:1.

Suitable amine (II) components needed for synthesizing the inventive aminoalkylene phosphonic acids can be represented by a wide variety of known species. Examples of preferred amines (II) include: ammonia; alkylene amines; alkoxy amines; halogen substituted alkyl amines; alkyl amines; and alkanol amines.

The amine component can also be represented by amino acids, such as α-, β-, γ-, δ-, ε-, etc. amino acids such as arginine, histidine, iso-leucine, leucine, methionine, threonine, phenylalanine, D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine.

It is understood that poly species are embraced. As an example, the term “alkyl amines” also includes -polyalkyl amines-, -alkyl polyamines- and -polyalkyl polyamines-. Individual species of amines of interest include: ammonia; ethylene diamine; diethylene triamine; triethylene tetraamine; tetraethylene pentamine; hexamethylene diamine; dihexamethylene triamine; 1,3-propane diamine-N,N′-bis(2-aminomethyl); polyether amines and polyether polyamines; 2-chloroethyl amine; 3-chloropropyl amine; 4-chlorobutyl amine; primary or secondary amines with C₁-C₂₅ linear or branched or cyclic hydrocarbon chains, in particular morpholine; n-butylamine; isopropyl amine; cyclohexyl amine; laurylamine; stearyl amine; and oleylamine; polyvinyl amines; polyethylene imine, branched or linear or mixtures thereof; ethanolamine; diethanolamine; propanolamine; dipropanol amine; D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine.

The essential formaldehyde component is a well known commodity ingredient. Formaldehyde sensu stricto known as oxymethylene having the formula CH₂O is produced and sold as water solutions containing variable, frequently minor, e.g. 0.3-3%, amounts of methanol and are typically reported on a 37% formaldehyde basis although different concentrations can be used. Formaldehyde solutions exist as a mixture of oligomers. Such formaldehyde precursors can, for example, be represented by paraformaldehyde, a solid mixture of linear poly(oxymethylene glycols) of usually fairly short, n=8-100, chain length, and cyclic trimers and tetramers of formaldehyde designated by the terms trioxane and tetraoxane respectively.

The formaldehyde component can also be represented by aldehydes and ketones having the formula R₁R₂C═O wherein R₁ and R₂ can be identical or different and are selected from the group of hydrogen and organic radicals. When R₁ is hydrogen, the material is an aldehyde. When both R₁ and R₂ are organic radicals, the material is a ketone. Species of useful aldehydes are, in addition to formaldehyde, acetaldehyde, caproaldehyde, nicotinealdehyde, crotonaldehyde, glutaraldehyde, p-tolualdehyde, benzaldehyde, naphthaldehyde and 3-aminobenzaldehyde. Suitable ketone species for use herein are acetone, methylethylketone, 2-pentanone, butyrone, acetophenone and 2-acetonyl cyclohexanone.

Preferred as the formaldehyde component is oxymethylene, also in oligomeric or polymeric form, in particular as an aqueous solution.

The liquid P₄O₆ for use herein can be represented by a substantially pure compound containing at least 85%, preferably more than 90%; more preferably at least 95% and in one particular execution at least 97% of the P₄O₆. While tetraphosphorus hexa oxide, suitable for use within the context of this invention, can be manufactured by any known technology, in preferred executions the hexa oxide is prepared in accordance with the process disclosed in WO 2009/068636 entitled “Process for the manufacture of P₄O₆” and/or WO 2010/055056, entitled “Process for the manufacture of P₄O₆ with improved yield”. In detail, oxygen, or a mixture of oxygen and inert gas, and gaseous or liquid phosphorus are reacted in essentially stoichiometric amounts in a reaction unit at a temperature in the range from 1600 to 2000° K, by removing the heat created by the exothermic reaction of phosphorus and oxygen, while maintaining a preferred residence time of from 0.5 to 60 seconds followed by quenching the reaction product at a temperature below 700° K and refining the crude reaction product by distillation. The hexa oxide so prepared is a pure product containing usually at least 97% of the oxide.

The P₄O₆ so produced is generally represented by a liquid material of high purity containing in particular low levels of elementary phosphorus, P₄, preferably below 1000 ppm, expressed in relation to the P₄O₆ being 100%. The preferred residence time is from 5 to 30 seconds, more preferably from 8 to 30 seconds. The reaction product can, in one preferred execution, be quenched to a temperature below 350° K.

The term “liquid P₄O₆” embraces as spelled out, any state of the P₄O₆. However, it is presumed that the P₄O₆, participating in a reaction of from 45° C. to 200° C. is necessarily liquid or gaseous although solid species can, academically speaking, be used in the preparation of the reaction medium.

In a preferred embodiment P₄O₆ (mp. 23.8° C.; bp. 173° C.) in liquid form is added to the aqueous reaction medium having a pH at all times below 5. The P₄O₆ is added to the reaction mixture under stirring generally starting at ambient temperature. The reaction medium can contain the amine (II) although the amine (II) can also be added simultaneously with the P₄O₆ or after the addition (hydrolysis) of the P₄O₆ has been completed, whereby the pH of the reaction medium is also maintained, at all times, below 5, preferably below 3, most preferably equal to or below 2.

This reaction medium thus contains the P₄O₆ hydrolysate and the amine (II), possibly as a salt. The hydrolysis is conducted at ambient temperature conditions (20° C.) up to about 150° C. While higher temperatures e.g. up to 200° C., or even higher, can be used such temperatures generally require the use of an autoclave or can be conducted in a continuous manner, possibly under autogeneous pressure built up. The temperature increase during the P₄O₆ addition can result from the exothermic hydrolysis reaction and was found to provide temperature conditions to the reaction mixture as can be required for the reaction with the formaldehyde component. In the event the P₄O₆ hydrolysis is conducted in the presence of the amine (II) then the amine (II) is present in the reaction medium before adding the P₄O₆ or the amine is added simultaneously with the P₄O₆. The inventive method can be conducted under substantial exclusion of added water beyond the stoichiometric level required for the hydrolysis of the P₄O₆. However, it is understood that the reaction inherent to the inventive method i.e. the formation of N—C—P bonds will generate water. In any case, the balance of phosphorous acid including the excess is added before the addition of the formaldehyde component.

After the P₄O₆ hydrolysis has been completed, the amount of residual water is such that the weight of water is from 0% to 60% expressed in relation to the weight of the amine.

The reaction in accordance with this invention is conducted in a manner routinely known in the domain of the technology. As illustrated in the experimental showings, the method can be conducted by combining the essential reaction partners and heating the reaction mixture to a temperature usually within the range of from 45° C. to 200° C., and higher temperatures if elevated pressures are used, more preferably 70° C. to 150° C. The upper temperature limit actually aims at preventing any substantially undue thermal decomposition of the phosphorous acid reactant. It is understood and well known that the decomposition temperature of the phosphorous acid, and more in general of any other individual reaction partners, can vary depending upon additional physical parameters, such as pressure and the qualitative and quantitative parameters of the ingredients in the reaction mixture.

The inventive reaction can be conducted at ambient pressure and, depending upon the reaction temperature, under distillation of water, thereby also eliminating a minimal amount of non-reacted formaldehyde. The duration of the reaction can vary from virtually instantaneous, e.g. 1 minute, to an extended period of e.g. 10 hours. This duration generally includes the gradual addition, during the reaction, of formaldehyde and possibly other reactants. In one method set up, the phosphorous acid and the amine are added to the reactor followed by heating this mixture under gradual addition of the formaldehyde component starting at a temperature e.g. in the range of from 70° C. to 150° C. This reaction can be carried out under ambient pressure with or without distillation of usually water and some non-reacted formaldehyde.

In another operational arrangement, the reaction can be conducted in a closed vessel under autogeneous pressure built up. In this method, the reaction partners, in total or in part, are added to the reaction vessel at the start. In the event of a partial mixture, the additional reaction partner can be gradually added, alone or with any one or more of the other partners, as soon as the effective reaction temperature has been reached. The formaldehyde component can, for example, be added gradually during the reaction alone or with parts of the amine (II) or the phosphorous acid.

In yet another operational sequence, the reaction can be conducted in a combined distillation and pressure arrangement. Specifically, the reaction vessel containing the reactant mixture is kept under ambient pressure at the selected reaction temperature. The mixture is then, possibly continuously, circulated through a reactor operated under autogeneous (autoclave principle) pressure built up thereby gradually adding the formaldehyde component or additional reaction partners in accordance with needs. The reaction is substantially completed under pressure and the reaction mixture then leaves the closed vessel and is recirculated into the reactor where distillation of water and other non-reacted ingredients can occur depending upon the reaction variables, particularly the temperature.

The foregoing process variables thus show that the reaction can be conducted by a variety of substantially complementary arrangements. The reaction can thus be conducted as a batch process by heating the initial reactants, usually the phosphorous acid and the amine in a (1) closed vessel under autogeneous pressure built up, or (2) under reflux conditions, or (3) under distillation of water and minimal amounts of non-reacted formaldehyde component, to a temperature preferably in the range of from 70° C. to 150° C. whereby the formaldehyde component is added, as illustrated in the Examples, gradually during the reaction. In a particularly preferred embodiment, the reaction is conducted in a closed vessel at a temperature in the range of from 100° C. to 150° C., coinciding particularly with the gradual addition of formaldehyde component, within a time duration of from 1 minute to 30 minutes, in a more preferred execution from 1 minute to 10 minutes.

In another approach, the reaction is conducted as a continuous process, possibly under autogeneous pressure, whereby the reactants are continuously injected into the reaction mixture, at a temperature preferably in the range of from 70° C. to 150° C. and the phosphonic acid reaction product is withdrawn on a continuous basis.

In yet another arrangement, the method can be represented by a semi-continuous set-up whereby the phosphonic acid reaction is conducted continuously whereas preliminary reactions between part of the components can be conducted batch-wise.

The aminoalkylene phosphonic acid reaction product can subsequently, and in accordance with needs, be neutralized, in part or in total, with ammonia, amines, alkali hydroxides, earth-alkali hydroxides or mixtures thereof.

The invention is illustrated by the following example without limiting it thereby.

### EXAMPLE 1

In a three-necked round-bottom flask equipped with a mechanical stirrer and a Dean-Stark tube, 15 g (0.25 mol) of ethylenediamine were mixed with 164 g (2 mol, 4 eq. for the reaction and 4 eq. as acid catalyst) of phosphorous acid and 60 mL of water. The reaction mixture was heated to reflux and water was distilled through the Dean-Stark tube until the reaction mixture temperature reached 136° C. 83 mL of a 36.6 wt.-% aqueous solution of formaldehyde (4.6 eq.) were then added over 260 min. During the addition 92 mL water were removed from the reaction mixture through the Dean-Stark tube while keeping the temperature of the reaction mixture between 130 and 136° C. ³¹P NMR analysis of the reaction mixture showed that ethylene diamine tetra (methylene phosphonic acid) (EDTMPA) was formed in 48.2% yield and the ethylene diamine N-methyl N,N′,N′-tri(methylene phosphonic acid) in 28.8% yield. After cooling and seeding with EDTMPA crystals, precipitation occurred and the crude product was recovered by filtration.

### EXAMPLE 2

In a three-necked round-bottom flask equipped with a mechanical stirrer and a Dean-Stark tube, 32.8 g of 6-amino hexanoic acid (0.25 moles) were mixed with 102.5 g (1.25 mol, 2 eq. for the reaction and 3 eq. as acid catalyst) of phosphorous acid and 30 mL of water. The reaction mixture was heated to reflux and water was distilled through the Dean-Stark tube until the reaction mixture temperature reached 130° C. 43.3 mL of a 36.6 wt.-% aqueous solution of formaldehyde (0.575 moles) were then added over 124 min. During the addition 47 mL water were removed from the reaction mixture through the Dean-Stark tube while keeping the temperature of the reaction mixture between 130 and 136° C. ³¹P NMR analysis of the reaction mixture showed that a 6-amino hexanoic acid bis (methylene phosphonic acid) was formed with 91.4% w/w yield. After cooling and water addition the phosphonic acid crystallized and can be recovered by filtration.

### EXAMPLE 3

In a three-necked round-bottom flask equipped with a mechanical stirrer and a Dean-Stark tube, 37.54 g of glycine (0.50 moles) were mixed with 205 g (2.5 moles, 2 eq. for the reaction and 3 eq. as acid catalyst) of phosphorous acid and 30 mL of water. The reaction mixture was heated to reflux and water was distilled through the Dean-Stark tube until the reaction mixture temperature reached 136° C. 86.6 mL of a 36.6 wt.-% aqueous solution of formaldehyde (1.15 moles) were then added over 217 min. During the addition 88 mL water were removed from the reaction mixture through the Dean-Stark tube while keeping the temperature of the reaction mixture between 130 and 136° C. ³¹P NMR analysis of the reaction mixture showed that glycine bis (methylene phosphonic acid) is formed with 80.7% w/w yield. After cooling, crystallization of the phosphonic acid occurred; the glycine diphosphonic acid (103.7 g dry 80% yield) can be recovered by filtration and subsequent drying.

### Comparative Example 4 Without an Excess of Phosphorous Acid

The example was performed with 85.28 g of phosphorous acid (1.04 moles), 21.46 g of diethylene triamine (0.208 moles), 10 g of water and 89.5 g of formaldehyde (36.6% solution; 1.092 moles) in the following conditions. The reactants, including 40% of the amine, were charged at the start of the reaction. 60% of the amine, together with the formaldehyde, was added, over a period of 30 minutes, during the reaction starting at 130° C. The reaction mixture showed 5.2% yield of diethylenetriamine penta(methylene phosphonic acid).

### Comparative Example 5 Without an Excess of Phosphorous Acid

In a three-necked round-bottom flask equipped with a mechanical stirrer and a Dean-Stark tube, 30.05 g of ethylene diamine (0.5 moles) were mixed with 164 g (2 moles) of phosphorous acid and 55 mL of water. The reaction mixture was heated to 114° C. and 120.33 g of a 36.6 wt.-% aqueous solution of formaldehyde (2.2 moles) were then added over 80 min. During the addition 156 mL water were removed from the reaction mixture through the Dean-Stark tube while keeping the temperature of the reaction mixture between 110 and 118° C. ³¹P NMR analysis of the reaction mixture showed that ethylene diamine tetra (methylene phosphonic acid) at 0.4% w/w with 3.1% w/w remaining unreacted phosphorous acid and 62.7% w/w of phosphoric acid. The balance 33.9% w/w is made of mono- and di-methylene phosphonic acid derivatives from ethylene diamine.

In this example, in absence of an excess of phosphorous acid, the major compound was phosphoric acid instead of aminoalkylene phosphonic acid.

These comparative examples 4 and 5 clearly highlighted that an excess of phosphorous acid is needed to afford aminoalkylene phosphonic acid in good yield and with excellent selectivity.

1. A method for the manufacture of aminoalkylene phosphonic acids having the formula (I):
(X)ₐ[N(W)(Y)₂₋ₐ]_{z} (I)
wherein X is selected from C₁-C₂₀₀₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; ZPO₃M₂; [V—N(K)]ₙ—K; [V—N(Y)]ₙ—V or [V—O]ₓ—V, wherein V is selected from: a C₂₋₅₀ linear, branched, cyclic or aromatic hydrocarbon radical, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical, wherein G is selected from C₁-C₂₀₀₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; ZPO₃M₂; [V—N(K)]ₙ—K; [V—N(Y)]ₙ—V or [V—O]ₓ—V; wherein Y is ZPO₃M₂, [V—N(K)]ₙ—K or [V—N(K)]ₙ—V and x is an integer from 1-50000; z is from 0-200000, whereby z is equal to or smaller than the number of carbon atoms in X, and a is 0 or 1; n is an integer from 1 to 50000; z=1 when a=0; and X is [V—N(K)]ₙ—K or [V—N(Y)]ₙ—V when z=0 and a=1;
Z is a methylene group;
M is selected from H, protonated amine, ammonium, alkali and earth-alkali cations;
W is selected from H, X and ZPO₃M₂ with the proviso that X and W cannot simultaneously represent CH₂COOH; and
K is ZPO₃M₂ or H whereby K is ZPO₃M₂ when z=0 and a=1 or when W is H or X;
a) by reacting an amine having the general formula (II):
(X)_{b}[N(W)(H)_{2-b}]_{z} (II)
wherein X is selected from C₁-C₂₀₀₀₀₀ linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; H; [V—N(H)]ₓ—H or [V—N(Y)]ₙ—V or [V—O]ₓ—V wherein V is selected from: a C₂₋₅₀ linear, branched, cyclic or aromatic hydrocarbon radical, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical; wherein G is selected from C₁-C₂₀₀₀₀₀ linear, branched, cyclic or aromatic hydrocarbon radicals, optionally substituted by one or more C₁-C₁₂ linear, branched, cyclic and/or aromatic groups, which radicals and/or which groups are optionally substituted by OH, COOH, COOR′, F, Br, Cl, I, OR′, SO₃H, SO₃R′ and/or SR′ moieties; H; [V—N(H)]ₙ—H; [V—N(Y)]ₙ—V or [V—O]ₓ—V; wherein Y is H, [V—N(H)]ₙ—H or [V—N(H)]ₙ—V and x is an integer from 1-50000; n is an integer from 0 to 50000; z is from 0-200000 whereby z is equal to or smaller than the number of carbon atoms in X, and b is 0, 1 or 2; z=1 when b=0; and X is [V—N(H)]ₓ—H or [V—N(Y)]ₙ—V, b=1 and n is an integer from 1 to 50000 when z=0; with W=H when X different from H and b=2; z=1 when W and X are hydrogen.
W is selected from H and X with the proviso that X and W cannot simultaneously represent CH₂COOH; and
phosphorous acid, in excess of from 100% to 600%, which excess is calculated by multiplying the sum of the N atoms in the amine by the number of moles of amine being reacted multiplied by 1 to 6 to thus determine the number of moles of phosphorous acid to be used in addition to the stoichiometric level required by the reaction; and formaldehyde; at a temperature in the range of from 45° C. to 200° C. for a period of from 1 minute to 10 hours, to thereby yield a reaction product, which is insoluble in the reaction medium and;
b) separating from the mother liquid and optionally washing the insoluble reaction product.

2. The method in accordance with claim 1, wherein the reactant ratios: (α) phosphorous acid; (β) amine; and (γ) formaldehyde are as follows:
(α):(β) from 0.05:1 to 2:1;
(γ):(β) from 0.05:1 to 5:1; and
(γ):(α) from 5:1 to 0.25:1;
whereby (α) and (γ) stand for the number of moles and (β) represents the number of moles multiplied by the number of N—H functions in the amine (II) whereby (α) represents the phosphorous acid reagent exclusive of the excess.

3. The method in accordance with claim 2, wherein the reactant ratios (α) phosphorous acid; (β) amine (II); and (γ) formaldehyde component are as follows:
(α):(β) of from 0.1:1 to 1.50:1;
(γ):(β) of from 0.2:1 to 2:1; and
(γ):(α) of from 3:1 to 0.5:1.
wherein (α) represents the phosphorous acid reagent exclusive of the excess.

4. The method in accordance with claim 1, wherein the amine (II) is selected from the group of: ammonia; alkylene amines; alkoxy amines; halogen substituted alkyl amines; alkyl amines; alkanol amines; polyethylene imine; polyvinyl amine and amino acids.

5. The method in accordance with claim 4, wherein the amine is selected from: ammonia; ethylene diamine; diethylene triamine; triethylene tetraamine; tetraethylene pentamine; hexamethylene diamine; dihexamethylene triamine; 1,3-propane diamine-N,N′-bis(2-aminomethyl); polyether amines and polyether polyamines; 2-chloroethyl amine; 3-chloropropyl amine; 4-chlorobutyl amine; primary or secondary amines with C₁-C₂₅ linear or branched or cyclic hydrocarbon chains, in particular morpholine; n-butylamine; isopropyl amine; cyclohexyl amine; laurylamine; stearyl amine; and oleylamine; polyvinyl amines; polyethylene imine, branched or linear or mixtures thereof; ethanolamine;
diethanolamine; propanolamine; dipropanol amine, D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine.

6. The method in accordance with claim 1, wherein the phosphorous acid is present in excess of 100% to 500%.

7. The method in accordance with claim 6, wherein the phosphorous acid is present in excess of 200% to 400%.

8. The method, in accordance with claim 1, wherein the mother liquid is, after the separation of the reaction product, recycled into the reaction medium.

9. The method in accordance with claim 1, wherein the reaction is carried out at a temperature in the range of from 70° C. to 150° C. combined with an approach selected from:
conducting the reaction under ambient pressure with or without distillation of water and non-reacted formaldehyde component;
in a closed vessel under autogeneous pressure built up;
in a combined distillation and pressure arrangement whereby the reaction vessel containing the reactant mixture is kept under ambient pressure at the reaction temperature followed by circulating the reaction mixture through a reactor operated under autogeneous pressure built up thereby gradually adding the formaldehyde and other selected reactants in accordance with needs; and
a continuous process arrangement, possibly under autogeneous pressure built up, whereby the reactants are continuously injected into the reaction mixture and the phosphonic acid reaction product is withdrawn on a continuous basis.

10. The method in accordance with claim 1, wherein the reaction is conducted at a temperature of from 115° C. to 145° C.

11. The method in accordance with claim 1, wherein the phosphorous acid is prepared starting from PCl₃, and contains less than 400 ppm of chlorine, expressed in relation to the phosphorous acid (100%).

12. The method in accordance with claim 1, wherein the phosphorous acid is prepared in situ by adding liquid P₄O₆ to an aqueous reaction medium, having at all times a pH below 5, said reaction medium being selected from:
is an aqueous reaction medium containing the amine (II);
ii: an aqueous reaction medium wherein the amine (II) is added simultaneously with the P₄O₆; and
iii: an aqueous reaction medium wherein the amine (II) is added after the addition/hydrolysis of the P₄O₆ has been completed.

13. The method in accordance with claim 12, wherein the pH in the aqueous reaction medium is, during the addition of the liquid P₄O₆, at all times below 3.

14. The method in accordance with claim 13, wherein the pH of the reaction medium is kept, during the adding of the liquid P₄O₆ to the aqueous reaction medium, equal to 2 or below.

15. The method in accordance with claim 12, wherein the P₄O₆ hydrolysis and the reaction of the P₄O₆ hydrolysate and the amine (II) with the formaldehyde component is conducted in a single continuous manner, possibly under autogeneous pressure built up, at a temperature from 70° C. to 200° C. and the phosphonic acid reaction product is withdrawn on a continuous basis.

16. The method in accordance with claim 12, wherein the P₄O₆ is manufactured by reacting oxygen and phosphorus in essentially stoichiometric amounts in a reaction unit at a temperature in the range of from 1600 to 2000° K with a reaction residence time from 0.5 to 30 seconds, followed by quenching the reaction product at a temperature below 700° K and refining the reaction product by distillation.

17. The method in accordance with claim 16, wherein the level of elementary phosphorous in the P₄O₆ is below 1000 ppm, expressed in relation to P₄O₆ (100%).
